(19) United States
(12) Patent Application Publication
(10) Pub. No.: US 2008/0143686 A1
(43) Pub. Date: Jun. 19, 2008

(54) INTEGRATED VEHICLE CONTROL INTERFACE AND MODULE

(76) Inventors: I-Hau Yeh, Hsinchu (TW); Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,527

(22) Filed: Sep. 24, 2007

(30) Foreign Application Priority Data
Dec. 15, 2006 (TW) 095147200

(51) Int. Cl. G06F 3/041

(52) U.S. Cl. 345/173

(57) ABSTRACT

An integrated vehicle control interface and module are provided for being disposed onto a direction control device of a vehicle. The integrated vehicle control module comprises a touch-control input/output component and a sense-and-control module. The touch-control input/output component is used for a driver to perform a touch-control input, and the sense-and-control module is used to sense and calculate a coordinate corresponding to the touch-control input and execute a corresponding functional mode with the coordinate.

### FIELD OF THE INVENTION

The present invention is related generally to a control interface and module, and more particularly, to an integrated vehicle control interface and module.

### BACKGROUND OF THE INVENTION

As living standard and technology advance with each passing day, much recent interest has been directed towards the development and application of all-in-one technology in both 3C and motor vehicle industries while a multi-function integrated vehicle control interface is just a materialization of this very idea, which helps integrating and simplifying the input/output and operation interfaces of vehicle control system. In FIGS. 1A and 1B, a conventional vehicle control interface and a conventional auxiliary operation interface thereof are respectively depicted. As can be seen in the drawing, the conventional vehicle control interface 12 is typically positioned at the upper or side surface of a central armrest 11 (which in the present embodiment is at the upper surface) between two front seats 10, and achieves integrated vehicle control by means of a large control knob 13 and a related auxiliary operation interface 15 arranged on a dashboard 14. Therein, a menu containing a variety of functions, such as communication, navigation, entertainment, air-conditioning, vehicle setting, operation preference, operating manual and customer service can be controlled through rotating the control knob 13. Additionally, the conventional vehicle control interface 12 may have some more pressing keys 16 for controlling other functions. However, as such a conventional vehicle control interface implements a directional knob 13 settled on the armrest 11 for controlling the multi-function menu or cursor movement, one problem with such an arrangement is that the driver has to move his right hand away from the steering wheel to operate the knob 13 with complex operating steps, and this in turn reduces the convenience of system operation and safety of driving.

On the other hand, except for the foregoing mechanical knob, a remote control has also been introduced recently for operating a vehicle control system. Such remote control may implement a plurality of navigation keys or numeral keys as operating means and may also work in conjunction with a dashboard or a liquid crystal display for operating a multi-function menu. FIG. 2 is provided for illustrating another embodiment of a conventional vehicle control interface, which is a remote control 20 having a plurality of first pressing keys 21 (e.g. navigation keys), a plurality of second pressing keys 22 (e.g. numeral keys), a liquid crystal display 23 and a pointing component 24. Therein, the liquid crystal display 23 can be simply a display device or alternatively a touch-control input/output component, whereupon, a driver or a passenger in the vehicle may utilize the components of the vehicle control interface 20 to operate the vehicle control system.

Nevertheless, known vehicle control interfaces generally employ navigation keys, pointing components or independent mechanical knobs as means of input and control. As to the navigation keys, each set is typically coming in five or nine keys with potential concerns of mechanical durability and limitation of directional flexibility and can only perform simple shift of the menu. When confronted with increasing demand of multimedia application, particularly position fixing and cursor moving, said mechanical means has become insufficient for meeting an operator's demands and required laborious operation. Further, some integrated vehicle remote control may add a touch-control panel to simulate the pointing function of a mouse, and a driver may often transfer his hand, sight and attention from the steering wheel to the armrest or dashboard where the operating means is located. Such an arrangement is not only inconsistent with the concept of ergonomics and intuitive operation, but also dangerous. Furthermore, some small liquid crystal displays in vehicles are merely used for displaying DVD and performing digital programs, and it is uneconomic that such displays are not integrated and used to the fullest extent. Thus, if such displays can be concurrently used for showing function menu, the vehicle control system can be benefited from reduced spatial occupancy of devices in vehicles and lowered costs of the installed components.

### SUMMARY OF THE INVENTION

The present invention has been accomplished under these circumstances in view and provided an integrated vehicle control interface and module comprising at least one touch-control input/output component and for being disposed onto a direction control device of a vehicle to facilitate a driver operating a control system with a more intuitive and convenient menu.

To achieve these and other objectives of the present invention, the integrated vehicle control interface is to be disposed onto a direction control device of a vehicle and comprises at least one touch-control input/output component for receiving and transmitting a driver's service request. Wherein the integrated vehicle control interface simulates a keyboard interface with a handwriting input interface and a first display device, and the service request includes input/output of alphanumeric and graphical symbols. Alternatively, the integrated vehicle control interface can include a pointing component to simulate a hardware/software mouse interface and a remote control device; the service request can further include menu selecting, address book selecting, navigation map operating and scroll bar as well as cursor controlling. Also, the integrated vehicle control interface of the present invention can be electrically connected to a control module for analyzing the service request, and then providing relevant service. Also, the integrated vehicle control interface of the present invention can be electrically connected to a second display device for displaying a graphic auxiliary operation interface that the service request demands and the operation status of the integrated vehicle control interface. Further, the integrated vehicle control interface of the present invention can be electrically connected to a wireless transceiver module, which is electrically connected to the control module to receive and transmit the service request through radio.

The integrated vehicle control interface of the present invention is for being disposed onto a direction control device of a vehicle and comprising a touch-control input/output component and a sense-and-control module wherein the touch-control input/output component is for allowing a driver to operate via touch-control, and the sense-and-control module is for sensing a control signal generated from the touch-control; calculating a coordinate corresponding to the touch-control; and implementing a corresponding functional mode according to the coordinate.

Therefore, since the present invention has the pointing component, touch-control input/output component and the combination thereof integrated with the steering wheel, the driver can easily operate the vehicle control system for the functions such as menu selecting, cursor moving and so on with a few fingers only (e.g. one thumb) instead of moving his hands and sight significantly away from the steering wheel. Thus, the present invention facilitates not only the convenience and safety of driving, but also the reduction of spatial occupancy of devices in vehicles and lowering the cost of installing components.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1A is a schematic view of one exemplar conventional vehicle control interface;

FIG. 1B is a schematic view of a conventional auxiliary operation interface of vehicle control interface;

FIG. 2 is a schematic view of another exemplar conventional vehicle control interface;

FIG. 3A is a schematic view showing the integrated vehicle control interface according to the first embodiment of the present invention;

FIG. 3B is a schematic view showing the integrated vehicle control interface according to the second embodiment of the present invention;

FIG. 3C is a schematic view showing the integrated vehicle control interface according to the third embodiment of the present invention;

FIG. 4 is a diagram illustrating the integrated vehicle control interface according to one embodiment of the present invention; and

FIG. 5 is a diagram illustrating the integrated vehicle control module according to one embodiment of the present invention.

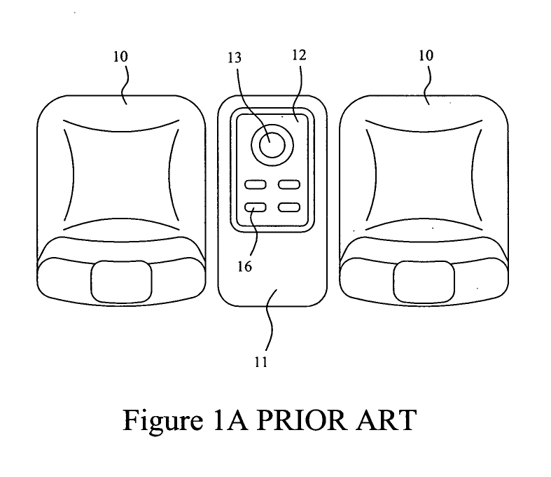

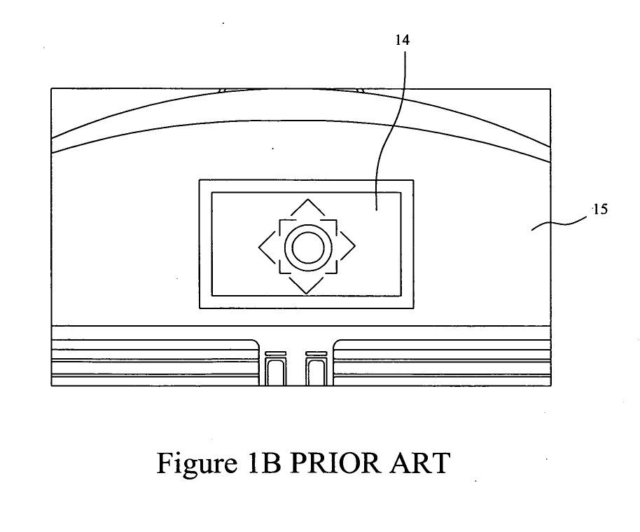

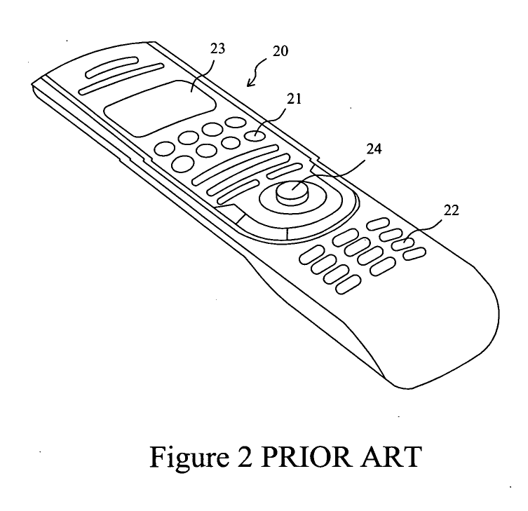

### DETAILED DESCRIPTION OF THE INVENTION

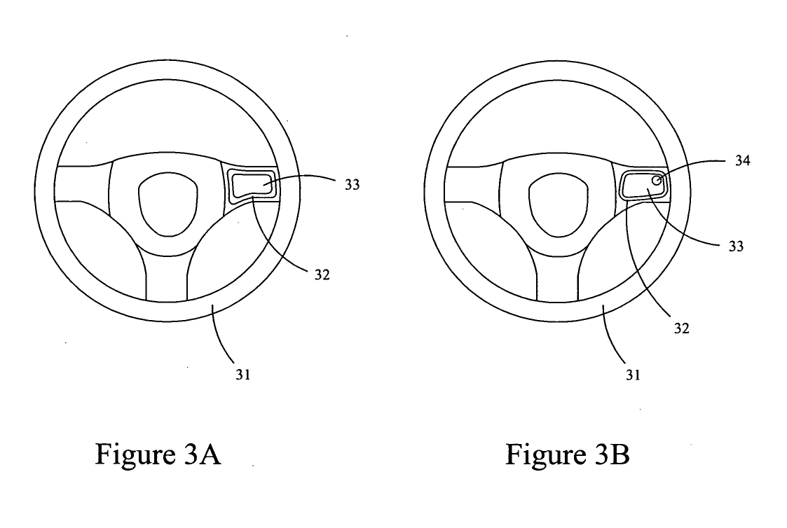

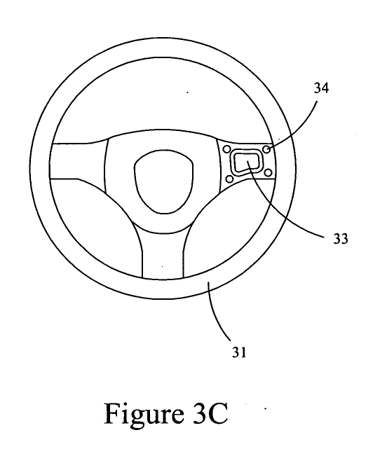

Referring to FIG. 3A, which is schematic illustrates one embodiment of the integrated vehicle control interface for vehicle of the present invention. As can be seen in the drawing, a direction control device 31 of a vehicle (which is a steering wheel in the present embodiment and may by other hand-operable devices, such as handle bars of a motorcycle) is installed with an integrated vehicle control interface 32 for receiving and transmitting a driver's service request. A touch-control input/output component 33 contained therein (which is a touch-control panel in the present embodiment) can be of a digital type or an analog type depending on the underlying sensing methods.

Generally speaking, a touch-control panel is composed of transparent conductive glass (which is a glass substrate coated with conductive Indium Tin Oxide), transparent conductive film (ITO Film) and flexible tail. A digital touch-control panel may substitute traditional keys. The fundamental principle upon which a digital touch-control panel is based is that the transparent conductive glass and the transparent conductive membrane are wired respectively along X axis and Y axis in the manner that a switch is formed at the point where the wires crossed each other. A pressing on the touch-control panel would make the switch on or off. An analog touch-control panel is implemented in several ways: resistive, capacitive, surface acoustic wave, electromagnetic, infrared, and optical, in which the resistive and capacitive touch panels are most popular types. Currently, resistive analog touch-control panels are typically applied to small-sized products and capacitive analog touch-control panels are mainly implemented for producing large-sized public inquiry systems while surface acoustic wave and infrared ones are employed for particular or medical purposes due to their high resolution.

Reference is now made to FIGS. 3B and 3C. According to the presently illustrated embodiment, the disclosed integrated vehicle control interface 32 can also comprise at least one pointing component 34 functioning in conjunction with the touch-control input/output component 33 to achieve a dual input system. Furthermore, the pointing component 34 can be positioned according to various considerations, such as the size of the direction control device 31, ergonomic factors, and the driver's preference (for instance, left-handed or right-handed). In FIG. 3B, the pointing component 34 is integrated with the touch-control input/output component 33, while dissimilarly, in FIG. 3C, the touch-control input/output component 33 and at least one pointing component 34 are separately arranged on an identical direction control device 31 in the manner that the distance there between, the relative position, and the amount are determined to optimize a driver's operation. It is to be noted that the recited embodiment is for the purpose of illustration and the described proportion, amount and size of the components should not be regarded as a limitation to the present invention.

In the embodiments depicted in FIGS. 3A, 3B and 3C, the integrated vehicle control interfaces 32 contains at least one touch-control input/output component 33, as a driver intends to input alphanumeric and graphical symbols, integrated vehicle control interfaces 32 can simulate a physical keyboard having a numeral input/output area, a software simulated graphic keyboard interface, and a handwriting input interface so that a driver can use a pen-like input component or his finger to write, draw, make record, and send alphanumeric symbols (such as dialing a call or writing a reminder) or drawings. Additionally, the integrated vehicle control interfaces 32 can also function as a first display device to substitute for a liquid crystal display or hardware/software display interface settled on a dashboard, and display the operation status of the graphic auxiliary operation interface, as well as the integrated vehicle control interface that a driver needs, and this achieves the objectives of integration and low cost.

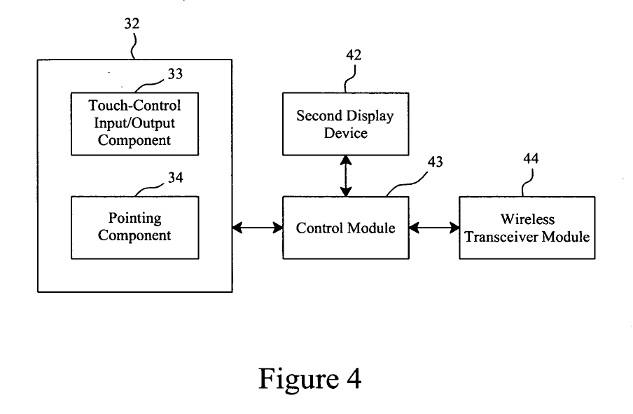

FIG. 4 provides a diagram illustrating the integrated vehicle control interface according to one embodiment of the present invention. In this embodiment, on account of definition and integration of other systems (such as an existing multi-media center), the integrated vehicle control interface 32 of the present invention can be electrically connected to a second display device 42 to display requested graphic auxiliary interface, operation status and so on. Besides, when a driver needs software interface such as scrolling and cursor controlling, menu selecting, address book, and navigation map, the integrated vehicle control interface 32 integrated with the touch-control input/output component 33 and pointing component 34 can also simulate hardware/software mouse interface and a remote control device. Moreover, the integrated vehicle control interface 32 can be electrically connected to a control module 43, such as a microprocessor, a microcontroller and the integrated circuit or a system-on-chip, to analyze a driver's service requests, generate corresponding control signals, and then provide relevant services. Furthermore, the integrated vehicle control interface 32 can comprise a wireless transceiver module 44, which is electrically connected to the control module 43, so as to receive and transmit service requests and related control signals through radio.

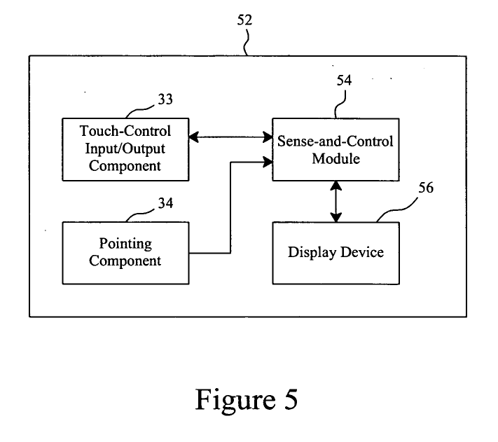

In addition, FIG. 5 shows a diagram illustrating the integrated vehicle control module according to one embodiment of the present invention. As can be seen, the integrated vehicle control interface 52 contains a touch-control input/output component 33, pointing component 34, sense-and-control module 54 and a display device 56. The touch-control input/output component 33 is provided for allowing a driver of touch input, simulating and displaying a keyboard interface and handwriting input interface, simulating a hardware/software mouse component and a remote control device in conjunction with the pointing component 34, selecting from service menu, selecting address book, operating navigation map, and controlling scroll bar as well as cursor. Also, the touch-control input/output component 33 can be further used to display the corresponding graphic auxiliary operation interface and operation status, and the touch-control input/output component 33 can be a digital one or an analog, which has been described above and will not be discussed at length herein. Plus, the sense-and-control module 54 can sense the control signal generated from touch input, calculate the corresponding coordinate and implement corresponding functional mode according to the coordinate. The display device 56 is electrically connected to the sense-and-control module 54 to display the corresponding graphic auxiliary operation interface and operation status, and meet a user's need for reading the needed information through a larger-size or higher definition display.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as string forth in the appended claims.

What is claimed is:

1. An integrated vehicle control interface for being disposed onto a direction control device of a vehicle, comprising a touch-control input/output component for receiving and transmitting a driver's service request.

2. The integrated vehicle control interface of claim 1, wherein the integrated vehicle control interface is used to simulate a keyboard interface, a handwriting input interface and a first display device, and the service request includes input/output of alphanumeric characters and graphical symbols.

3. The integrated vehicle control interface of claim 2, wherein the keyboard interface includes a physical keyboard and a software for simulating graphic keyboard interface.

4. The integrated vehicle control interface of claim 3, wherein the keyboard interface has a numeral input/output area and the service request includes making phone calls.

5. The integrated vehicle control interface of claim 2, further comprising:
a pointing component for being disposed onto the direction control device, wherein the integrated vehicle control interface is used to simulate a hardware/software mouse interface and a remote control device, and the service request further includes service menu selecting, address book selecting, navigation map operating, scrolling and cursor controlling

6. The integrated vehicle control interface of claim 2, wherein the integrated vehicle control interface is used to simulate the handwriting input interface, and the service request is inputable by means of a pen-like input component or one of users' fingers.

7. The integrated vehicle control interface of claim 2, wherein the integrated vehicle control interface displays a graphic auxiliary operation interface as demanded by the service request and an operation status of the integrated vehicle control interface when the integrated vehicle control interface is used to simulate the first display device.

8. The integrated vehicle control interface of claim 1, wherein the integrated vehicle control interface is electrically connected to a control module which is used to analyze the service request and provide relevant service as demanded by the service request.

9. The integrated vehicle control interface of claim 8, further comprising a wireless transceiver module electrically connected to the control module for receiving and transmitting the service request by wireless communications.

10. The integrated vehicle control interface of claim 8, wherein the integrated vehicle control interface is electrically connected to a second display device which is used to display a graphic auxiliary operation interface the service request demands and an operation status of the integrated vehicle control interface.

11. The integrated vehicle control interface of claim 1, wherein the touch-control input/output component is of digital type or analog type.

12. An integrated vehicle control module for being disposed onto a direction control device of a vehicle, comprising:
a touch-control input/output component for a driver to perform a touch-control input; and
a sense-and-control module for sensing a control signal generated from the touch-control input, calculating a coordinate corresponding to the touch-control input, and executing a corresponding functional mode with the coordinate.

13. The integrated vehicle control module of claim 12, wherein the touch-control input/output component is used to simulate and display a keyboard interface and a handwriting input interface.

14. The integrated vehicle control module of claim 12, further comprising:
a pointing component for being disposed onto the direction control device, in association with the touch-control input/output component to simulate a hardware/software mouse interface and a remote control device, wherein the functional mode includes service menu selecting, address book selecting, navigation map operating, scrolling and cursor controlling.

15. The integrated vehicle control module of claim 12, wherein the touch-control input/output component is of digital type or analog type.

16. The integrated vehicle control module of claim 12, wherein the touch-control input/output component is further used to display a graphic auxiliary operation interface corresponding to the functional mode and an operation status.

17. The integrated vehicle control module of claim 12, further comprising:
a display device electrically connected to the sense-and-control module to display a graphic auxiliary operation interface corresponding to the functional mode and an operation status.
